(19) United States
(12) Patent Application Publication
(10) Pub. No.: US 2026/0197870 A1
(43) Pub. Date: Jul. 9, 2026

(54) APPARATUS, SYSTEM, AND METHOD OF CONFIGURING MULTI-ACCESS POINT (AP) OPERATION

(71) Applicant: INTEL CORPORATION, Santa Clara, CA (US)

(72) Inventors: Laurent Cariou, Milizac (FR); Thomas J. Kenney, Portland, OR (US)

(73) Assignee: INTEL CORPORATION, Santa Clara, CA (US)

(21) Appl. No.: 19/132,815

(22) PCT Filed: Dec. 25, 2022
(86) PCT No.: PCT/US2022/054015

§ 371 Date: May 25, 2025

(51) Int. Cl. H04W 74/0816; H04W 52/36; H04W 74/0833

(52) U.S. Cl. CPC H04W 74/0816; H04W 52/367; H04W 74/085

(57) ABSTRACT

For example, an Access Point (AP) may be configured to set a multi-AP parameter field in a Target Wake Time (TWT) parameter set field to configure multi-AP operation. For example, the multi-AP parameter field may include information to configure the multi-AP operation during a TWT Service Period (SP). For example, the AP may be configured to transmit a TWT element. For example, the TWT element may include the TWT parameter set field. For example, a wireless communication station (STA) may be configured to receive the TWT element from the AP, and to identify the multi-AP parameter field in the TWT element. For example, the STA may be configured to communicate one or more transmissions during the TWT SP based on the multi-AP parameter field.

### TECHNICAL FIELD

Aspects described herein generally relate to configuring multi-Access Point (AP) operation.

### BACKGROUND

Some wireless communication networks may provide high-throughput data for users of wireless communication devices.

There is a need for technical solutions to provide increased and/or efficient access to the wireless communication medium.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic illustration of multi-Access Point (AP) operation scheme, in accordance with some demonstrative aspects.

FIG. 5 is a schematic flow-chart illustration of a method of configuring multi-AP operation, in accordance with some demonstrative aspects.

FIG. 6 is a schematic flow-chart illustration of a method of configuring multi-AP operation, in accordance with some demonstrative aspects.

FIG. 7 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D2.0 Draft Standard for Information technology-Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), May 2022)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by a mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

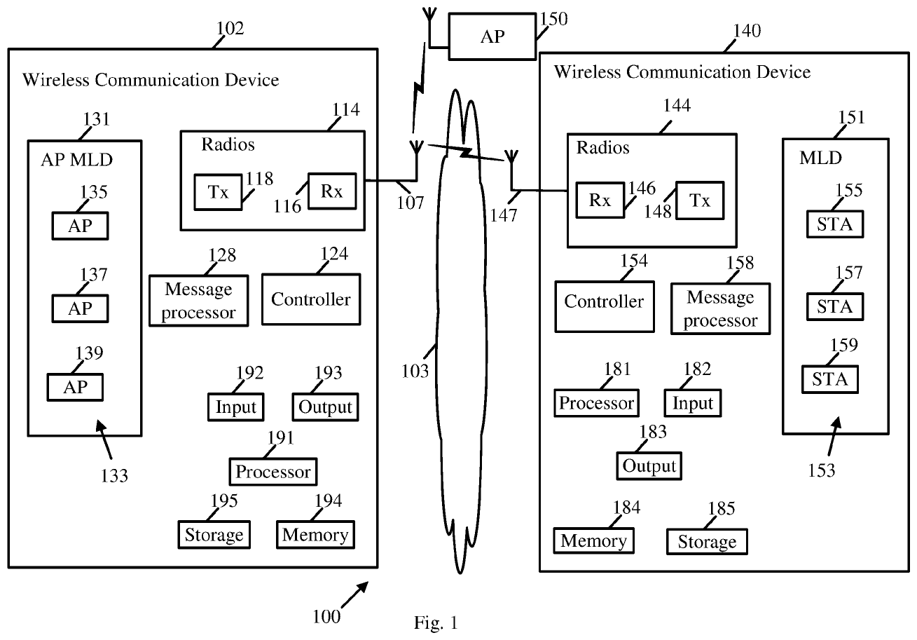

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 150, and/or one or more other devices.

In some demonstrative aspects, devices 102, 140 and/or 150 may include a mobile device or a non-mobile, e.g., a static, device.

For example, devices 102, 140 and/or 150 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 150 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternative include one or more channels in an mmWave wireless communication frequency band.

In other aspects, WM 103 may include any other type of channel over any other frequency band.

In some demonstrative aspects, device 102, device 140, and/or device 150 may include one or more radios including circuitry and/or logic to perform wireless communication between devices 102, 140, 150 and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an S1G band, and/or any other band.

In some demonstrative aspects, radios 114 and/or 144 may include, or may be associated with one or more, e.g., a plurality of, antennas.

In some demonstrative aspects, device 102 may include one or more antennas 107, e.g., a single antenna 107 or a plurality of antennas 107, and/or device 140 may include one or more antennas 147, e.g., a single antenna 147 or a plurality of antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 150 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 150 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 150 may include, operate as, perform the role of, and/or perform one or more functionalities of, one or more STAs. For example, device 102 may include at least one STA, device 140 may include at least one STA, and/or device 150 may include at least one STA.

In some demonstrative aspects, device 102, device 140, and/or device 150 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, devices 102, 140 and/or 150 may be configured to perform one or more operations, and/or functionalities of a WiFi 8 STA.

In other aspects, for example, devices 102, 140 and/or 150 may be configured to perform one or more operations, and/or functionalities of an Ultra High Reliability (UHR) STA.

In other aspects, for example, devices 102, 140 and/or 150 may be configured to perform one or more operations, and/or functionalities of any other additional or alternative type of STA.

In other aspects, device 102, device 140, and/or device 150 may include, operate as, perform the role of, and/or perform one or more functionalities of, any other wireless device and/or station, e.g., a WLAN STA, a WiFi STA, and the like.

In some demonstrative aspects, device 102, device 140, and/or device 150 may be configured operate as, perform the role of, and/or perform one or more functionalities of, an access point (AP), e.g., an EHT AP STA.

In some demonstrative aspects, device 102, device 140, and/or device 150 may be configured to operate as, perform the role of, and/or perform one or more functionalities of, a non-AP STA, e.g., an EHT non-AP STA.

In other aspects, device 102, device 140, and/or device 150 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 150 may be configured to communicate in an EHT network, and/or any other network.

In some demonstrative aspects, devices 102, 140, and/or 150 may be configured to operate in accordance with one or more Specifications, for example, including one or more IEEE 802.11 Specifications, e.g., an IEEE 802.11-2020 Specification, an IEEE 802.11be Specification, and/or any other specification and/or protocol.

In some demonstrative aspects, device 102, device 140, and/or device 150 may include, operate as, perform a role of, and/or perform the functionality of, one or more multi-link logical entities, e.g., as described below.

In other aspect, device 102, device 140, and/or device 150 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102, device 140, and/or device 150 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity and has more than one affiliated STA and has a single MAC service access point (SAP) to LLC, which includes one MAC data service. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 150 may be configured to operate as, perform the role of, and/or perform one or more functionalities of, an AP MLD.

In some demonstrative aspects, device 102, device 140, and/or device 150 may be configured to operate as, perform the role of, and/or perform one or more functionalities of, a non-AP MLD.

In other aspects, device 102, device 140, and/or device 150 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to cause, trigger, instruct and/or control device 102 to operate as, perform a role of, and/or perform one or more operations and/or functionalities of, an AP MLD 131 including a plurality of AP STAs 133, e.g., including an AP STA 135, an AP STA 137 and/or an AP STA 139. In some aspects, as shown in FIG. 1, AP MLD 131 may include three AP STAs. In other aspects, AP MLD 131 may include any other number of AP STAs.

In one example, AP STA 135, AP STA 137 and/or AP STA 139 may operate as, perform a role of, and/or perform one or more operations and/or functionalities of, an EHT AP STA. In other aspects, AP STA 135, AP STA 137 and/or AP STA 139 may perform any other additional or alternative functionality.

In some demonstrative aspects, for example, the one or more radios 114 may include, for example, a radio for communication by AP STA 135 over a first wireless communication frequency channel and/or frequency band, e.g., a 2.4 GHz band, as described below.

In some demonstrative aspects, for example, the one or more radios 114 may include, for example, a radio for communication by AP STA 137 over a second wireless communication frequency channel and/or frequency band, e.g., a 5 GHz band, as described below.

In some demonstrative aspects, for example, the one or more radios 114 may include, for example, a radio for communication by AP STA 139 over a third wireless communication frequency channel and/or frequency band, e.g., a 6 GHz band, as described below.

In some demonstrative aspects, the radios 114 utilized by APs 133 may be implemented as separate radios. In other aspects, the radios 114 utilized by APs 133 may be implemented by one or more shared and/or common radios and/or radio components.

In other aspects, controller 124 may be configured to cause, trigger, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to cause, trigger, instruct and/or control device 140 to operate as, perform a role of, and/or perform one or more operations and/or functionalities of, an MLD 151 including a plurality of STAs 153, e.g., including a STA 155, a STA 157 and/or a STA 159. In some aspects, as shown in FIG. 1, MLD 151 may include three STAs. In other aspects, MLD 151 may include any other number of STAs.

In one example, STA 155, STA 157 and/or STA 159 may operate as, perform a role of, and/or perform one or more operations and/or functionalities of, an EHT STA. In other aspects, STA 155, STA 157 and/or STA 159 may perform any other additional or alternative functionality.

In some demonstrative aspects, for example, the one or more radios 144 may include, for example, a radio for communication by STA 155 over a first wireless communication frequency channel and/or frequency band, e.g., a 2.4 GHz band, as described below.

In some demonstrative aspects, for example, the one or more radios 144 may include, for example, a radio for communication by STA 157 over a second wireless communication frequency channel and/or frequency band, e.g., a 5 GHz band, as described below.

In some demonstrative aspects, for example, the one or more radios 144 may include, for example, a radio for communication by STA 159 over a third wireless communication frequency channel and/or frequency band, e.g., a 6 GHz band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to cause, trigger, instruct and/or control MLD 151 to operate as, perform a role of, and/or perform one or more operations and/or functionalities of, a non-AP MLD. For example, STA 155, STA 157 and/or STA 159 may operate as, perform a role of, and/or perform one or more operations and/or functionalities of, a non-AP EHT STA.

In some demonstrative aspects, controller 154 may be configured to cause, trigger, instruct and/or control MLD 151 to operate as, perform a role of, and/or perform one or more operations and/or functionalities of, an AP MLD. For example, STA 155, STA 157 and/or STA 159 may operate as, perform a role of, and/or perform one or more operations and/or functionalities of, an AP EHT STA.

In other aspects controller 154 may be configured to cause, trigger, instruct and/or control device 140 to operate as, perform a role of, and/or perform one or more operations and/or functionalities of, any other additional or alternative entity and/or STA, e.g., a single STA, multiple STAs, and/or a non-MLD entity.

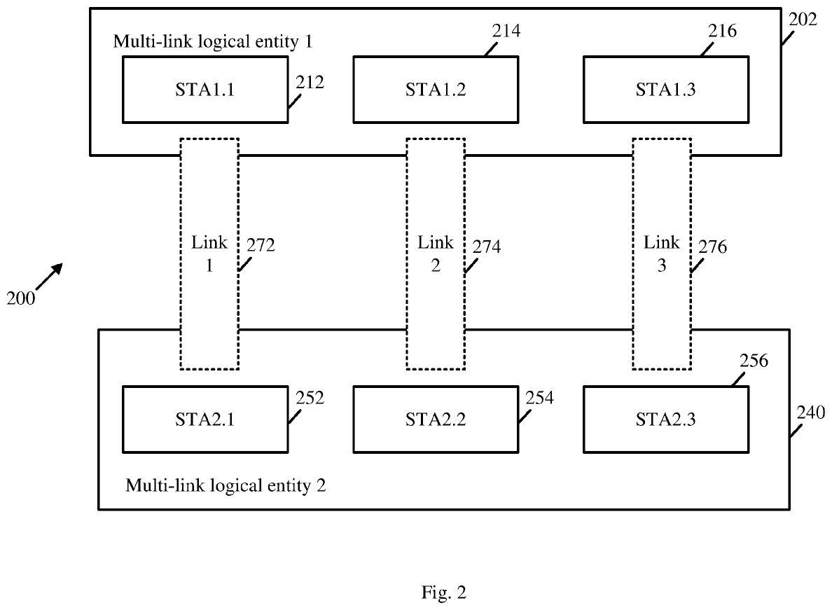

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, and a STA 216. In one example, AP MLD 131 (FIG. 1) may perform one or more operations, one or more functionalities, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, and a STA 256. In one example, MLD 151 (FIG. 1) may perform one or more operations, one or more functionalities, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, and/or a link 276 between STA 216 and STA 256.

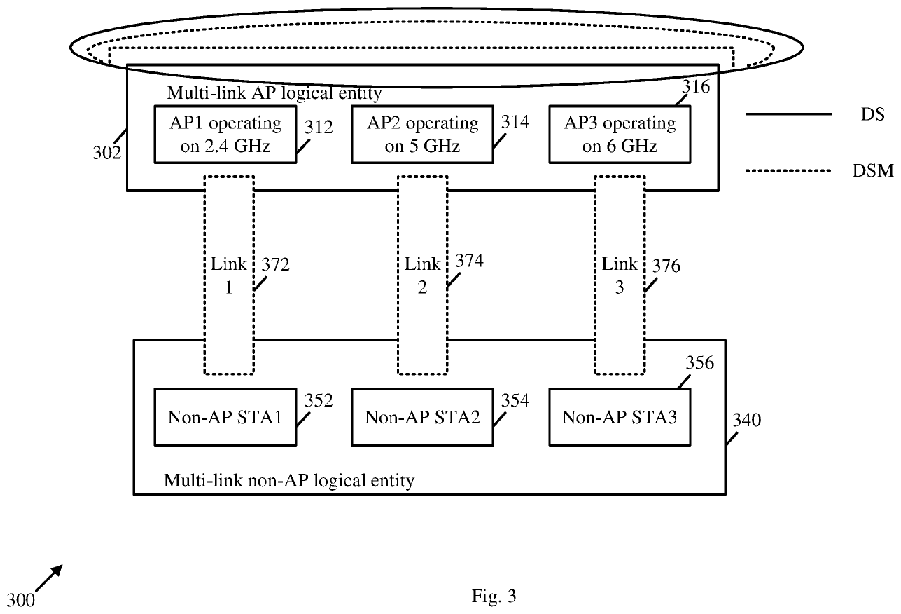

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, and an AP STA 316. In one example, AP MLD 131 (FIG. 1) may perform one or more operations, one or more functionalities, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, and a non-AP STA 356. In one example, MLD 151 (FIG. 1) may perform one or more operations, one or more functionalities, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, and/or a link 376 between AP STA 316 and non-AP STA 356.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 GHz frequency band, AP STA 314 may be configured to communicate over a 5 GHz frequency band, and/or AP STA 316 may be configured to communicate over a 6 GHz frequency band. In other aspects, AP STA 312, AP STA 314, and/or AP STA 316, may be configured to communicate over any other additional or alternative wireless communication frequency bands.

Referring back to FIG. 1, in some demonstrative aspects, devices 102, 140 and/or 150 may be configured to perform wireless communication according to multi-AP operation mechanism, e.g., as described below.

In some demonstrative aspects, the multi-AP operation mechanism may be configured to provide a technical solution to support cooperation, e.g., improved cooperation, between APs in a same cooperation group. For example, the improved cooperation between the APs may support better coordination of users, resources, e.g., spatially, temporally and/or spectrally. This improved coordination of users and/or resources may support improved overall system operation, e.g., as described below.

In some demonstrative aspects, the multi-AP operation mechanism may be configured to support one or more multi-AP coordinated operations between a plurality of APs, e.g., as described below.

In some demonstrative aspects, the multi-AP operation mechanism may be configured to support communication between a plurality of APs sharing one or more communication resources, e.g., as described below.

In some demonstrative aspects, the multi-AP operation mechanism may be configured to support an AP (“sharing AP”) to share one or more communication resources with one or more other APs (“shared APs”), e.g., as described below.

In some demonstrative aspects, a sharing AP may gain access to communication resources, for example, by gaining access to a Transmit Opportunity (TxOP). For example, the sharing AP may share the communication resources with the shared APs according to one or more sharing techniques, e.g., as described below.

In some demonstrative aspects, the multi-AP operation mechanism may be configured to support sharing of communication resources, for example, according to a coordinated TDMA technique. For example, a sharing AP that gains a TxOP and accesses the wireless medium may share its TxOP with other shared APs, for example, by splitting the TxOP into multiple allocations in time, thus giving one or more time allocations to a shared AP or to the sharing AP.

In some demonstrative aspects, the multi-AP operation mechanism may be configured to support sharing communication resources, for example, according to a coordinated OFDMA technique. For example, a sharing AP that gains a TxOP and accesses the wireless medium may share its TxOP with other shared APs, for example, by splitting the TxOP into multiple allocations in frequency, and by giving one or more frequency allocations to a shared AP or to the sharing AP. For example, the sharing AP may determine the frequency allocations to ensure PPDU start and/or end time alignment, for example, to ensure there is no potential co-channel interference between the different frequency allocations.

In some demonstrative aspects, the multi-AP operation mechanism may be configured to support sharing communication resources, for example, according to a coordinated spatial reuse technique. For example, a sharing AP that gains a TxOP and accesses the wireless medium may share its TxOP with other shared APs, for example, by splitting the TxOP into multiple allocations in time, and by giving one or more frequency allocations to multiple shared AP or to the sharing AP. For example the sharing AP may determine the frequency allocations to reuse the wireless medium, e.g., in the frequency domain and/or the time domain.

For example, the sharing AP may utilize the coordinated spatial reuse technique to allocate the shared time and/or frequency resources, for example, while taking into consideration any potential interference, which may result from the sharing of the time and/or frequency resources.

For example, the sharing AP may utilize the coordinated spatial reuse technique to allocate the shared time and/or frequency resources, for example, such that the sharing of the time and/or frequency resources may result in substantially no interference, or in reduced interference, e.g., below a predefined interference level.

In some demonstrative aspects, the sharing AP may utilize the coordinated spatial reuse technique to allocate the shared time and/or frequency resources, for example, by coordinating a Transmit (Tx) power to be used for communication overt the shared time and/or frequency resources. For example, the sharing AP may coordinate a Tx power limit, which may limit the Tx power to be used for communication overt the shared time and/or frequency resources, e.g., as described below.

In some demonstrative aspects, the multi-AP operation mechanism may be configured to support sharing communication resources, for example, according to a coordinated beamforming technique. For example, a sharing AP that gains a TxOP and accesses the wireless medium may share its TxOP with other shared APs, for example, by coordinating beamforming settings to be used for communication over one or more shared communication resources.

In other aspects, the multi-AP operation mechanism may be configured to support sharing communication resources according to any other additional and/or alternative techniques.

In some demonstrative aspects, the multi-AP operation mechanism may be configured to implement a multi-AP trigger frame, which may be sent by the sharing AP to the shared APs, e.g., as described below.

In some demonstrative aspects, the multi-AP trigger frame may be configured to assign allocations of one or more communication resources, e.g., time and/or frequency allocations, to different shared APs and their associated STAs, for example, for the TxOP and/or for the allocation, e.g., as described below.

In some demonstrative aspects, the multi-AP trigger frame may include a Request-to-Send (RTS) frame.

In some demonstrative aspects, the multi-AP trigger frame may include a Multi User (MU) RTS (MU-RTS) frame, which may be configured to indicate a multi-AP operation, e.g., a multi-AP sharing mode.

In some demonstrative aspects, the MU-RTS frame may be configured to include a multi-AP sharing indication to indicate a multi-AP sharing. For example, the sharing AP may configure the MU RTS frame to include a predefined value in a sharing mode field of the MU RTS frame. For example, the sharing AP may configure the sharing mode field to include a predefined value to indicate a multi-AP sharing mode.

In other aspects, the multi-AP trigger frame may include any other type of frame.

In some demonstrative aspects, the multi-AP operation mechanism may be configured to define that, for example, based on the multi-AP trigger frame, one or more other devices, e.g., some or all APs and/or STAs, may contend for the wireless communication medium. For example, when a sharing AP gains access to the medium and starts a TxOP, the sharing AP may use the multi-AP trigger frame, for example, to share the medium with the shared APs, e.g., during the TxOP.

In some demonstrative aspects, the multi-AP operation mechanism may be configured to define that, normal contention and operation may be resumed, for example, once the TxOP ends.

In some demonstrative aspects, the multi-AP operation mechanism may be configured to provide a technical solution to support improved system throughput and/or one or more other gains, for example, with spatial reuse, e.g., as described below.

In some demonstrative aspects, the multi-AP operation mechanism may be configured to support coordination between a plurality of APs to participate in multi-AP sharing, e.g., as described below.

In some demonstrative aspects, the multi-AP operation mechanism may be implemented to support the plurality of APs to coordinate communication, for example, to ensure efficient resource allocation for resource sharing, e.g., as described below.

In some demonstrative aspects, the multi-AP operation mechanism may be implemented to support the plurality of APs to coordinate communication, for example, to ensure no interference, or reduced interference, over the shared resources, which are shared between STAs in BSSs controlled by the plurality of APs.

In some demonstrative aspects, the multi-AP operation mechanism may be implemented to support the plurality of APs to coordinate the allocation of the shared resources, for example, such that STAs that are relatively close to a serving AP and/or that are relatively far from a neighboring AP may be allocated with communication resources according to a spatial reuse technique, e.g., as described below.

In some demonstrative aspects, the multi-AP operation mechanism may be implemented to support the plurality of APs to coordinate the allocation of the shared resources, for example, such that STAs that are relatively far from a serving AP and/or that are relatively close to a neighboring AP may be allocated with communication resources according to a frequency sharing technique and/or a time sharing technique, e.g., as described below.

For example, the multi-AP operation mechanism may be implemented to support a first AP and a second AP to coordinate communications over one or more shared communication resources.

For example, the first AP and the second AP may coordinate communication over the shared resources according to a resource allocation, which may ensure that STAs which are relatively close to their serving AP and far from the neighbor AP, e.g., STAs in the center of each BSS, may communicate according to the spatial reuse, e.g., during one or more specific times.

For example, the first AP and the second AP may coordinate communication over the shared resources according to a resource allocation, which may ensure that STAs close to the BSS edge between the first and second APs, e.g., STAs that are at about equal distance between the first and second APs, may communicate according to frequency and/or time sharing of the wireless medium during one or more other times.

In some demonstrative aspects, the coordination between the plurality of APs participating in multi-AP sharing may provide one or more advantages, for example, in a fully managed environment where only APs are accessing the wireless medium and, accordingly, it is relatively easy to have all APs in synchronization and available to share their resources.

In some demonstrative aspects, the multi-AP operation mechanism may be implemented to provide an improved system throughput and/or any other gains, for example, in the fully managed environment where only APs are accessing the medium.

In some use cases, scenarios, deployments, and/or implementations, it may be more complex and/or difficult to achieve these gains. For example, in some realistic deployments there may be a relatively large amount of contention with STAs and/or other third party APs, which may affect the multi-AP coordination, e.g., as described below.

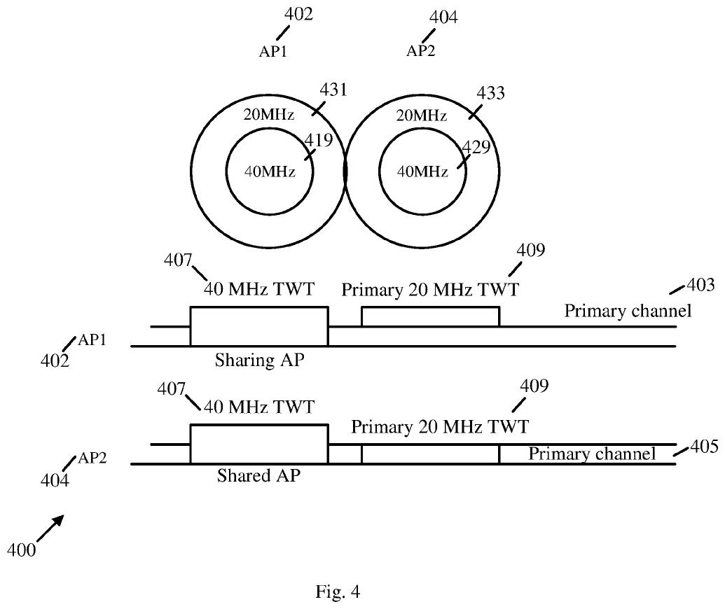

Reference is made to FIG. 4, which schematically illustrates a multi-AP operation scheme 400, which may be implemented in accordance with some demonstrative aspects.

In some demonstrative aspects, as shown in FIG. 4, an AP 402, e.g., an AP implemented by device 102 (FIG. 1), and/or an AP 404, e.g., an AP implemented by device 150 (FIG. 1), may share the same 40 MHz channel. For example, as shown in FIG. 4, each of AP 402 and AP 404 may operate on a different 20 MHz primary channel in the shared 40 MHz channel.

In some demonstrative aspects, the different primary channels may be utilized, for example, to support a possibility of an AP to fall back to the primary 20 MHz channel, for example, only when a secondary channel is busy, e.g., which may not allow using of the full 40 MHz bandwidth.

For example, as shown in FIG. 4, AP 402 may operate on a first primary channel, e.g., a first 20 MHz channel 403, in the shared 40 MHz channel. For example, as shown in FIG. 4, AP 404 may operate on a second primary channel, e.g., a 20 MHz channel 405, different from the first primary channel, in the shared 40 MHz channel.

For example, in some cases, AP 402 and/or AP 404 may end up, e.g., may very likely end up, out of synchronization. This may result in a situation where contention periods on the 20 MHz channel 403 and the 20 MHz channel 405 may not align. For example, this misalignment of both 20 MHz channels may result in a situation, where the AP 402 and the AP 404 may not really have a chance to operate over the wide 40 MHz bandwidth, and/or to have multi-AP coordination between the AP 402 and AP 404.

In some demonstrative aspects, AP 402 and/or AP 404 may communicate according to a multi-AP operation mechanism, which may be configured to utilize one or more Target Wake Time (TWT) periods, e.g., restricted TWT (rTWT) periods, to support multi-AP coordination between AP 402 and AP 404, e.g., as described below.

In some demonstrative aspects, the multi-AP operation mechanism may be configured to utilize the TWT periods to support coordination of spatial reuse of communication resources, for example, in a relatively easy and/or efficient way, e.g., as described below.

In some demonstrative aspects, the multi-AP operation mechanism may be configured to utilize the TWT periods to support spatial reuse, for example, based on transmit power control, e.g., as described below.

In some demonstrative aspects, as shown in FIG. 4, a 40 MHz TWT period 407, e.g., a 40 MHz rTWT period, may be utilized to coordinate sharing of the 40 MHz channel, for example, according to a spatial reuse technique. For example, the 40 MHz TWT period 407 may be utilized by the AP 402 and/or the AP 404 to serve one or more clients that are relatively close to their serving AP, e.g., STAs in an area 419 around AP 402 and/or in an area 429 around AP 404.

In some demonstrative aspects, as shown in FIG. 4, a 20 MHz TWT period 409, e.g., a 20 MHz rTWT period, may be utilized to coordinate communications over the primary 20 MHz channels, for example, for STAs, which may not be suitable for the spatial reuse. For example, the 20 MHz TWT period 409 may be utilized by the AP 402 and/or the AP 404 to serve one or more clients that are relatively far from their serving AP, and cannot benefit from the spatial reuse, STAs in an area 431 around AP 402 and/or in an area 433 around AP 404.

Referring back to FIG. 1, in some demonstrative aspects, devices 102, 140 and/or 150 may be configured to implement a multi-AP operation mechanism, which may be configured to utilize an rTWT, for example, to coordinate multi-AP operation, e.g., as described below.

In some demonstrative aspects, the rTWT may be utilized by the multi-AP operation mechanism, for example, to provide a technical solution to support improved multi-AP performance, e.g., as described below.

In some demonstrative aspects, device 102, device 140, and/or device 150 may be part of a set of APs (“AP candidate set”) for multi-AP operation, e.g., as described below.

In some demonstrative aspects, the AP candidate set may include a set of APs, which may be capable of operating in the role of sharing APs and/or shared APs.

In some demonstrative aspects, one or more APs of the AP candidate set, e.g., APs implemented by device 102 and/or device 150, may be configured to advertise a same TWT schedule, e.g., a restricted TWT schedule, or TWT Service Periods (SPs) with some minimal level of overlap.

For example, the APs of the AP candidate set, e.g., an AP of device 102 and an AP of device 150, may each advertise the same rTWT schedule to their served STAs. For example, each of devices 102 and 150 may advertise the same rTWT schedule, e.g., in a beacon.

For example, the APs of the AP candidate set, e.g., the APs of device 102 and/or device 150, may coordinate the same rTWT, for example, by backhaul, via an exchange of negotiation messages, and/or by any other type of connection.

In some demonstrative aspects, a TWT element may be configured to describe a TWT Service Period (SP) and/or a TWT schedule, e.g., as described below.

In some demonstrative aspects, an AP, e.g., an AP implemented by device 102 and/or device 150, may configure a TWT element in a frame to be sent by the AP, for example, based on a Timing Synchronization Function (TSF) of the AP, e.g., as described below.

For example, values in the TWT elements sent by all APs may be different. However, the values in the TWT elements sent by all APs may point to the same service period in time, e.g., a same start time and a same end time.

In some demonstrative aspects, the coordination of the rTWT SP between the APs, and the advertisement of the coordinated rTWT SP using the TWT element may support a technical solution to coordinate between all APs and/or STAs, for example, such that all STAs and/or APs in an AP candidate set may end, e.g., may have to end, their TxOP, e.g., if they had one, for example, before the start of the rTWT SP.

In some demonstrative aspects, the coordination of the rTWT SP between the APs, and the advertisement of the coordinated rTWT SP using the TWT element may support a technical solution to coordinate between all APs and/or STAs, for example, such that all the STAs and/or APs in the AP candidate set may start a contention period at the same time, e.g., as described below.

Accordingly, the coordination of the rTWT SP between the APs, and the advertisement of the coordinated rTWT SP using the TWT element may support a technical solution to coordinate between all APs and/or STAs, for example, such that all the STAs and APs in the AP candidate set may be aligned, e.g., fully aligned, for example, with respect to the shared communication resources.

In some demonstrative aspects, it may be defined that a Broadcast TWT element is to include one or more information fields, which may be configured, for example, to expand multi-AP operation during an rTWT service period, e.g., as described below.

In some demonstrative aspects, the Broadcast TWT element may include a maximal (Max) Transmit power field to include maximal transmit power information, e.g., as described below.

In some demonstrative aspects, the Broadcast TWT element may include one or more fields including user limitation (restriction) information to indicate one or more limitations on users during the rTWT SP.

For example, the user limitation information may indicate limitations on the number of users.

For example, the user limitation information may indicate the use of Enhanced Distributed Channel Access (EDCA) for one or more of the users, e.g., each of those users.

For example, the user limitation information may indicate a definition of a fixed backoff time, for example, to support better alignment of APs sharing the rTWT SP.

For example, the user limitation information may any other additional or alternative information.

In some demonstrative aspects, the Broadcast TWT element may include any additional or alternative fields including any other additional or alternative information.

In some demonstrative aspects, one or more rules may be defined for Uplink (UL) during the rTWT SP, for example, to allow an AP, e.g., each AP, to assign a slot to a STA at another time, for example, in case another STA has the current slot on the other BSS.

In some demonstrative aspects, controller 124 may be configured to control, trigger, cause, and/or instruct an AP implemented by device 102 to set a multi-AP parameter field in a TWT parameter set field, e.g., as described below.

In some demonstrative aspects, the multi-AP parameter field may include information to configure multi-AP operation during a TWT SP, e.g., as described below.

In some demonstrative aspects, the TWT SP may include an rTWT SP, e.g., as described below.

In some demonstrative aspects, the multi-AP parameter field may be after a restricted TWT traffic information field in the TWT parameter set field, e.g., as described below.

In some demonstrative aspects, controller 124 may be configured to control, trigger, cause, and/or instruct the AP implemented by device 102 to transmit a TWT element, which includes the TWT parameter set field, e.g., as described below.

In some demonstrative aspects, controller 124 may be configured to control, trigger, cause, and/or instruct the AP implemented by device 102 to transmit a broadcast transmission including the TWT element, e.g., as described below.

In some demonstrative aspects, the TWT parameter set field in the broadcast transmission may include a broadcast TWT parameter set field, e.g., as described below.

In some demonstrative aspects, controller 124 may be configured to control, trigger, cause, and/or instruct the AP implemented by device 102 to transmit a beacon including the TWT element.

In other aspects, the TWT element may be transmitted as part of any other additional or alternative type of transmission and/or frame.

In some demonstrative aspects, controller 124 may be configured to control, trigger, cause, and/or instruct the AP implemented by device 102 to transmit a multi-AP sharing trigger frame, for example, during a TxOP obtained by the AP during the TWT SP, e.g., as described below.

In some demonstrative aspects, the multi-AP sharing trigger frame may be configured to trigger multi-AP sharing of the TxOP, e.g., as described below.

In some demonstrative aspects, controller 154 may be configured to control, trigger, cause, and/or instruct a STA implemented by device 140 to process a TWT parameter field in a TWT element received from an AP, e.g., as described below.

In some demonstrative aspects, the TWT element may include the TWT element transmitted by device 102.

In some demonstrative aspects, controller 154 may be configured to control, trigger, cause, and/or instruct the STA implemented by device 140 to identify in the TWT element from the AP a multi-AP parameter field in the TWT parameter set field of the TWT element, e.g., as described below.

In some demonstrative aspects, controller 154 may be configured to control, trigger, cause, and/or instruct the STA implemented by device 140 to process the multi-AP parameter field to identify information to configure multi-AP operation during a TWT SP.

In some demonstrative aspects, controller 154 may be configured to control, trigger, cause, and/or instruct the STA implemented by device 140 to communicate one or more transmissions during the TWT SP, for example, based on the information in the multi-AP parameter field, e.g., as described below.

In some demonstrative aspects, the multi-AP parameter field may include a Tx power constraint field, which may be configured to indicate a constraint on a Tx power for transmission during the TWT SP, e.g., as described below.

In some demonstrative aspects, the multi-AP parameter field may include a maximal Tx power field, which may be configured to indicate a maximal Tx power for transmission during the TWT SP, e.g., as described below.

In some demonstrative aspects, the multi-AP parameter field may include a Power Spectral Density (PSD) limit field, which may be configured to indicate a PSD limit for transmission during the TWT SP, e.g., as described below.

In some demonstrative aspects, the multi-AP parameter field may include user-restriction information, which may be configured to restrict a count of users to communicate during the TWT SP, e.g., as described below.

In some demonstrative aspects, the multi-AP parameter field may include EDCA restriction information, which may be configured to indicate an EDCA restriction during the TWT SP, e.g., as described below.

In some demonstrative aspects, the EDCA restriction information may be configured to indicate that EDCA during the TWT SP is restricted to members of a TWT schedule, e.g., as described below.

In some demonstrative aspects, the multi-AP parameter field may include a direction field, which may be configured to indicate whether at least one of UL communication and/or DL communication is to be allowed during the TWT SP, e.g., as described below.

In some demonstrative aspects, the multi-AP parameter field may include a backoff field, which may be configured to indicate a duration of a backoff to be applied for channel access during the TWT SP, e.g., as described below.

In some demonstrative aspects, the multi-AP parameter field may include a multi-AP coordinated information field including multi-AP coordinated information to configure multi-AP coordinated communications during the TWT SP, e.g., as described below.

In some demonstrative aspects, the multi-AP parameter field may include one or more multi-AP coordinated communication parameters, which may be coordinated by the AP and one or more other APs, e.g., as described below.

In some demonstrative aspects, the one or more multi-AP coordinated communication parameters may configure communication during the TWT SP, e.g., as described below.

In some demonstrative aspects, the multi-AP parameter field may include one or more multi-AP coordinated communication parameters, which may be coordinated by a plurality of APs, which are to share the TWT SP, e.g., as described below.

In some demonstrative aspects, the plurality of APs may include a plurality of APs to share the TWT SP according to a time diversity scheme, e.g., as described below.

In some demonstrative aspects, the plurality of APs may include a plurality of APs to share the TWT SP according to a frequency diversity scheme, e.g., as described below.

In some demonstrative aspects, the plurality of APs may include a plurality of APs to share the TWT SP according to a spatial reuse scheme, e.g., as described below.

In some demonstrative aspects, device 102, device 140, and/or device 150 may be configured to implement a multi-AP operation mechanism to coordinate communication for multiple APs during a TWT SP, e.g., as described below.

In some demonstrative aspects, the multi-AP operation mechanism may provide a technical solution to support definition of one or more specific parameters for operation within the TWT SP, e.g., a Broadcast TWT SP, for example, an rTWT SP, and/or any other type of TWT SP.

In some demonstrative aspects, a TWT element, for example, a broadcast TWT element, and/or any other type of TWT element, may be configured to include one or more fields (“AP coordination fields”), which may be configured to include information (“AP coordination information”) to support AP coordination, for example, for multi-AP operation, e.g., as described below.

In some demonstrative aspects, the one or more AP coordination fields may be included, for example, in a Restricted TWT Traffic Information (Info.) field.

For example, the one or more AP coordination fields may be included at an end of the Restricted TWT Traffic Info. field.

For example, the Restricted TWT Traffic Info. field may be included as part of a TWT parameter set field, for example, according to a Broadcast TWT parameter set field format.

In some demonstrative aspects, the multi-AP operation mechanism may utilize the AP coordination information in the TWT element, for example, to support resource sharing, e.g., as described below.

In some demonstrative aspects, the multi-AP operation mechanism may support spatial reuse, for example, based on a Tx power constraint.

In some demonstrative aspects, the TWT element defining a TWT SP may be configured to include a Tx power constraint field, which may indicate a constraint on a Tx power for transmission during the TWT SP.

In some demonstrative aspects, the Tx power constraint field may include a maximal Tx power field to indicate a maximal (Max) Tx Power that is allowed to be used by a STA for transmission during the TWT SP, e.g., the rTWT SP, for example, if the STA is a member of the rTWT SP.

In some demonstrative aspects, the Tx power constraint field may be included in the TWT element, for example, to provide a technical solution to support spatial reuse between STAs.

For example, the Tx power constraint field may be used to indicate the Max Tx Power, which may be allowed for STAs to communicate according to the spatial reuse technique during the rTWT SP, e.g., STAs in the area 419 (FIG. 4) of AP 402 (FIG. 4), and/or STAs in the area 429 (FIG. 4) of AP 404 (FIG. 4).

In some demonstrative aspects, the Tx power constraint field may include a PSD limit field configured to indicate a PSD limit for transmission during the TWT SP.

In other aspects, the Tx power constraint field may include any other additional and/or alternative information fields, which may be configured to indicate any other additional or alternative constraints on a Tx power for transmission during the TWT SP.

In some demonstrative aspects, a number of users that may use an rTWT may be limited, e.g., as described below.

For example, one or more relatively strict rules may be defined, for example, to limit the number of users allowed to use the rTWT.

In some demonstrative aspects, a TWT element, e.g., a broadcast TWT element, defining a TWT SP may be configured to include a field to indicate one or more rules to be followed by members of the TWT SP and/or by non-members of the TWT SP. For example, in a broadcast TWT SP some STAs may become members of the broadcast TWT SP and/or some STAs may be non-members of the broadcast TWT SP, e.g., in accordance with the 802.11ax Specification.

In some demonstrative aspects, the TWT element may include an EDCA restriction field, which may be configured to indicate an EDCA restriction during the TWT SP, e.g., as described below.

In some demonstrative aspects, the EDCA restriction field may be implemented as a 1-bit flag field, which may be configured to indicate whether or not the EDCA restriction is to be applied during the TWT SP. For example, a first predefined value of the EDCA restriction field, e.g., 0, may indicate that the EDCA restriction is not to be applied during the TWT SP. For example, a second predefined value of the EDCA restriction field, e.g., 1, may indicate that the EDCA restriction is to be applied during the TWT SP.

In other aspects, the EDCA restriction field may be implemented by any other field of any other size and/or according to any other definition.

In some demonstrative aspects, the EDCA restriction field may be configured to indicate an EDCA restriction mode, which may be configured to allow the members of the TWT SP to use EDCA to access a channel during the restricted TWT, and to prohibit non-members of the TWT SP to use EDCA to access the channel during the restricted TWT.

In one example, the non-members of the TWT SP may pause, e.g., would pause, their EDCA backoff operation during the restricted TWT, for example, until an end indicated by the TWT element.

In another example, e.g., if defined and/or allowed, the non-members of the TWT SP may pause, e.g., would pause, their EDCA backoff operation during the restricted TWT, for example, until a specific indication is received that indicates the end of the restricted TWT.

In some demonstrative aspects, the TWT element, e.g., the broadcast TWT element, may be configured to indicate a direction of communication allowed during the TWT SP, for example, the rTWT SP, e.g., as described below.

In some demonstrative aspects, it may be defined that the TWT element, e.g., the broadcast element, is to include a direction field, which specifies the direction of communication, e.g., UL and/or DL, that is allowed during the restricted TWT SP. For example, it may be efficient to perform spatial reuse sharing, for example, by having APs sharing the same resources communicate in the same direction.

In some demonstrative aspects, the multi-AP operation mechanism may be configured to provide a technical solution to support a reduced chance of interference between overlapping transmissions, e.g., due to spatial reuse.

For example, the multi-AP operation mechanism may be configured to provide a technical solution to support tighter timing between PPDU start and end times of a PPDU in an indicated direction (UL/DL) and a response PPDU that follows in the other direction.

In some demonstrative aspects, the TWT element, e.g., the broadcast TWT element, may be configured to include a backoff field defining a duration of a backoff during the TWT SP, e.g., as described below.

In some demonstrative aspects, a fixed backoff, e.g., SIFS and/or any other predefined period of time, may be defined for DL transmissions. For example, the fixed backoff may be implemented to align transmissions of PPDUs from two APs that are sharing the same restricted TWT, e.g., advertising the same start and end and same parameters of rTWT SP, to start at substantially a same time.

In some demonstrative aspects, the TWT element, e.g., the broadcast TWT element, may be configured to include one or more multi-AP coordinated communication parameters to configure communication between two or more APs.

In one example, the one or more multi-AP coordinated communication parameters may specify the duration of the DL PPDU, and/or the duration of the UL response.

In another example, it may be specified that only one PPDU is allowed to be communicated during the TWT SP, e.g., while prohibiting back to back DL PPDUs.

In some demonstrative aspects, a fixed backoff, e.g., SIFS and/or any other predefined period of time, may be defined for UL transmissions. For example, the fixed backoff may be implemented for the UL, for example, when there is a single candidate STA for UL.

In some demonstrative aspects, a specific Backoff procedure may be defined, for example, when there is more than a single candidate STA for UL. For example, the specific Backoff procedure may be configured to work for a lesser number of STAs, while ensuring that if one STA gains access to the medium at a particular slot, another STA may, e.g., will, also gain access to the medium on the other BSS. In one example, the specific Backoff procedure may define a round robin channel access solution, for example, to ensure that both STA access the medium.

In some demonstrative aspects, there may be one or more rules to define the end time of the PPDU, e.g., without having any specific rules on the start time and/or the specific backoff procedure, and the duration of the response frame that may come right after the UL PPDU. In other aspects, a number of UL PPDUs within the rTWT may be limited to 1.

For example, one or more of the rules defined above may be used, for example, in case the direction is not defined.

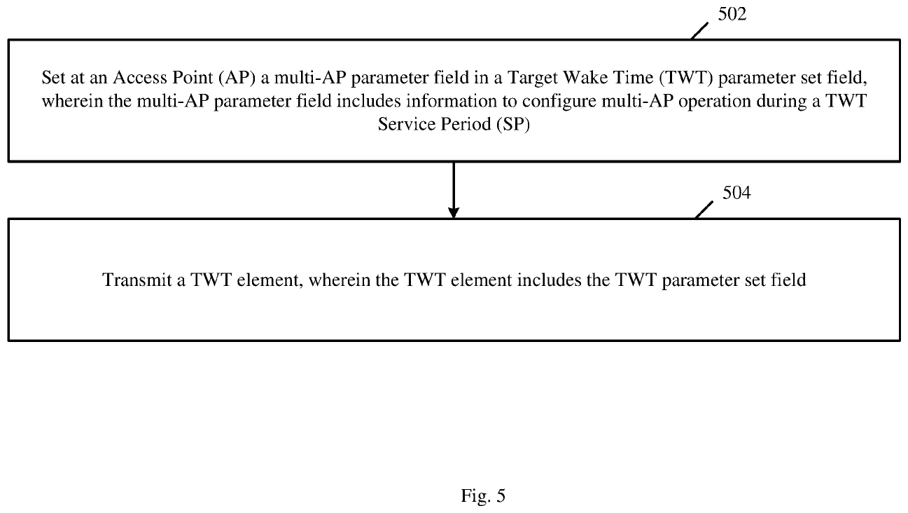

Reference is made to FIG. 5, which schematically illustrates a method of configuring multi-AP operation, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), and/or device 140 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include setting at an AP a multi-AP parameter field in a TWT parameter set field. For example, the multi-AP parameter field may be configured to include information to configure multi-AP operation during a TWT SP. For example, controller 124 (FIG. 1) may be configured to cause, trigger, and/or control device 102 (FIG. 1) to set a multi-AP parameter field in a TWT parameter set field, e.g., as described above.

As indicated at block 504, the method may include transmitting a TWT element, which includes the TWT parameter set field. For example, controller 124 (FIG. 1) may be configured to cause, trigger, and/or control device 102 (FIG. 1) to transmit a TWT element, which includes the TWT parameter set field, e.g., as described above.

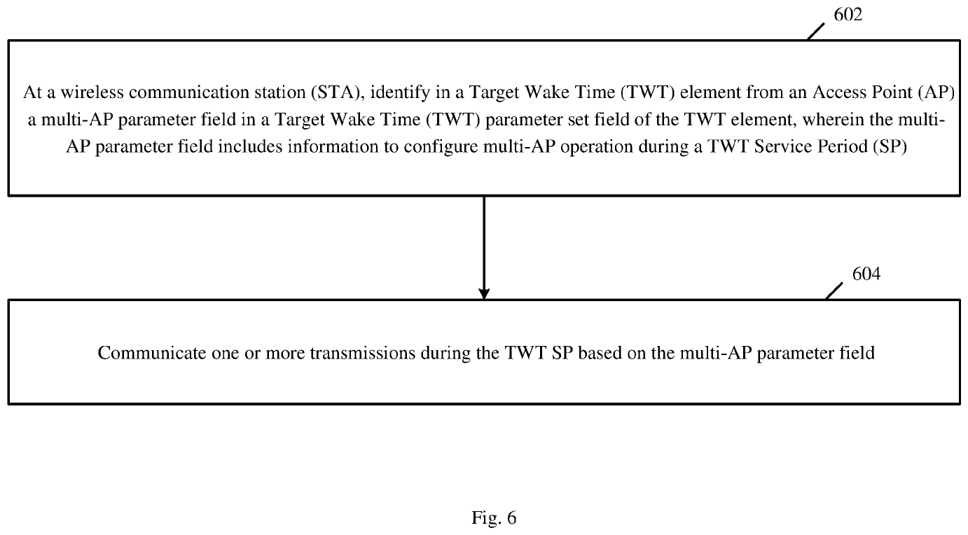

Reference is made to FIG. 6, which schematically illustrates a method of configuring multi-AP operation, in accordance with some demonstrative aspects. For example, one or more of the operations of the method of FIG. 6 may be performed by one or more elements of a system, e.g., system 100 (FIG. 1), for example, one or more wireless devices, e.g., device 102 (FIG. 1), and/or device 140 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 602, the method may include identifying at a STA a multi-AP parameter field in a TWT parameter set field of a TWT element from an AP. For example, the multi-AP parameter field may include information to configure multi-AP operation during a TWT SP. For example, controller 154 (FIG. 1) may be configured to cause, trigger, and/or control device 140 (FIG. 1) to identify in a TWT element received from an AP implemented by device 102 (FIG. 1) a multi-AP parameter field in a TWT parameter set field of the TWT element, e.g., as described above.

As indicated at block 604, the method may include communicating one or more transmissions during the TWT SP based on the multi-AP parameter field. For example, controller 154 (FIG. 1) may be configured to cause, trigger, and/or control device 140 (FIG. 1) to communicate one or more transmissions with device 102 (FIG. 1) during the TWT SP based on the multi-AP parameter field, e.g., as described above.

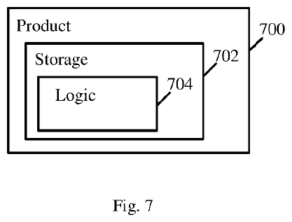

Reference is made to FIG. 7, which schematically illustrates a product of manufacture 700, in accordance with some demonstrative aspects. Product 700 may include one or more tangible computer-readable (“machine-readable”) non-transitory storage media 702, which may include computer-executable instructions, e.g., implemented by logic 704, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities, and/or to perform, trigger and/or implement one or more operations and/or functionalities described with reference to the FIGS. 1, 2, 3, 4, 5, and/or 6, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 700 and/or machine-readable storage media 702 may include one or more types of computer-readable storage media capable of storing data, including volatile memory, non-volatile memory, removable or non-removable memory, erasable or non-erasable memory, writeable or re-writeable memory, and the like. For example, machine-readable storage media 702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 704 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 704 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause an Access Point (AP) to set a multi-AP parameter field in a Target Wake Time (TWT) parameter set field, wherein the multi-AP parameter field comprises information to configure multi-AP operation during a TWT Service Period (SP); and transmit a TWT element, wherein the TWT element comprises the TWT parameter set field.

Example 2 includes the subject matter of Example 1, and optionally, wherein the multi-AP parameter field comprises a Transmit (Tx) power constraint field configured to indicate a constraint on a Tx power for transmission during the TWT SP.

Example 3 includes the subject matter of Example 1 or 2, and optionally, wherein the multi-AP parameter field comprises a maximal Transmit (Tx) power field configured to indicate a maximal Tx power for transmission during the TWT SP.

Example 4 includes the subject matter of any one of Examples 1-3, and optionally, wherein the multi-AP parameter field comprises a Power Spectral Density (PSD) limit field configured to indicate a PSD limit for transmission during the TWT SP.

Example 5 includes the subject matter of any one of Examples 1-4, and optionally, wherein the multi-AP parameter field comprises user-restriction information configured to restrict a count of users to communicate during the TWT SP.

Example 6 includes the subject matter of any one of Examples 1-5, and optionally, wherein the multi-AP parameter field comprises Enhanced Distributed Channel Access (EDCA) restriction information configured to indicate an EDCA restriction during the TWT SP.

Example 7 includes the subject matter of Example 6, and optionally, wherein the EDCA restriction information is configured to indicate that EDCA during the TWT SP is restricted to members of a TWT schedule.

Example 8 includes the subject matter of any one of Examples 1-7, and optionally, wherein the multi-AP parameter field comprises a direction field to indicate whether at least one of Uplink (UL) communication or Downlink (DL) communication is to be allowed during the TWT SP.

Example 9 includes the subject matter of any one of Examples 1-8, and optionally, wherein the multi-AP parameter field comprises a backoff field configured to indicate a duration of a backoff to be applied for channel access during the TWT SP.

Example 10 includes the subject matter of any one of Examples 1-9, and optionally, wherein the multi-AP parameter field comprises a multi-AP coordinated information field comprising multi-AP coordinated information to configure multi-AP coordinated communications during the TWT SP.

Example 11 includes the subject matter of any one of Examples 1-10, and optionally, wherein the multi-AP parameter field comprises one or more multi-AP coordinated communication parameters, which are coordinated by the AP and one or more other APs, wherein the one or more multi-AP coordinated communication parameters configure communication during the TWT SP.

Example 12 includes the subject matter of any one of Examples 1-11, and optionally, wherein the multi-AP parameter field comprises one or more multi-AP coordinated communication parameters coordinated by a plurality of APs, which are to share the TWT SP.

Example 13 includes the subject matter of Example 12, and optionally, wherein the plurality of APs comprises a plurality of APs to share the TWT SP according to a time diversity scheme.

Example 14 includes the subject matter of Example 12 or 13, and optionally, wherein the plurality of APs comprises a plurality of APs to share the TWT SP according to a frequency diversity scheme.

Example 15 includes the subject matter of any one of Examples 12-14, and optionally, wherein the plurality of APs comprises a plurality of APs to share the TWT SP according to a spatial reuse scheme.

Example 16 includes the subject matter of any one of Examples 12-15, and optionally, wherein the apparatus is configured to cause the AP to transmit a multi-AP sharing trigger frame during a Transmit Opportunity (TxOP) obtained by the AP during the TWT SP, wherein the multi-AP sharing trigger frame is to trigger multi-AP sharing of the TxOP.

Example 17 includes the subject matter of any one of Examples 1-16, and optionally, wherein the TWT SP comprises a restricted TWT (rTWT) SP.

Example 18 includes the subject matter of any one of Examples 1-17, and optionally, wherein the multi-AP parameter field is after a restricted TWT traffic information field in the TWT parameter set field.

Example 19 includes the subject matter of any one of Examples 1-18, and optionally, wherein the apparatus is configured to cause the AP to transmit a broadcast transmission comprising the TWT element, wherein the TWT parameter set field comprises a broadcast TWT parameter set field.

Example 20 includes the subject matter of any one of Examples 1-19, and optionally, wherein the apparatus is configured to cause the AP to transmit a beacon comprising the TWT element.

Example 21 includes the subject matter of any one of Examples 1-20, and optionally, comprising at least one radio to transmit the TWT element.

Example 22 includes the subject matter of Example 21, and optionally, comprising one or more antennas connected to the radio, and a processor to execute instructions of an operating system of the AP.

Example 23 includes an apparatus comprising logic and circuitry configured to cause a wireless communication station (STA) to identify a multi Access Point (AP) (multi-AP) parameter field in a Target Wake Time (TWT) parameter set field of a TWT element from an AP, wherein the multi-AP parameter field comprises information to configure multi-AP operation during a TWT Service Period (SP); and communicate one or more transmissions during the TWT SP based on the multi-AP parameter field.

Example 24 includes the subject matter of Example 23, and optionally, wherein the multi-AP parameter field comprises a Transmit (Tx) power constraint field configured to indicate a constraint on a Tx power for transmission during the TWT SP, wherein the apparatus is configured to cause the STA to constrain a Tx power of the STA for a transmission during the TWT SP based on the Tx power constraint field.

Example 25 includes the subject matter of Example 23 or 24, and optionally, wherein the multi-AP parameter field comprises a maximal Transmit (Tx) power field configured to indicate a maximal Tx power for transmission during the TWT SP, wherein the apparatus is configured to cause the STA to limit a Tx power of the STA for a transmission during the TWT SP based on the maximal Tx power field.

Example 26 includes the subject matter of any one of Examples 23-25, and optionally, wherein the multi-AP parameter field comprises a Power Spectral Density (PSD) limit field configured to indicate a PSD limit for transmission during the TWT SP, wherein the apparatus is configured to cause the STA to limit a PSD of the STA for a transmission during the TWT SP based on the PSD limit field.

Example 27 includes the subject matter of any one of Examples 23-26, and optionally, wherein the multi-AP parameter field comprises user-restriction information configured to restrict a count of users to communicate during the TWT SP, wherein the apparatus is configured to cause the STA to restrict transmissions from the STA during the TWT SP based on the user-restriction information.

Example 28 includes the subject matter of any one of Examples 23-27, and optionally, wherein the multi-AP parameter field comprises Enhanced Distributed Channel Access (EDCA) restriction information configured to indicate an EDCA restriction during the TWT SP, wherein the apparatus is configured to cause the STA to restrict an EDCA of the STA during the TWT SP based on the EDCA restriction information.

Example 29 includes the subject matter of Example 28, and optionally, wherein the EDCA restriction information is configured to indicate that EDCA during the TWT SP is restricted to members of a TWT schedule.

Example 30 includes the subject matter of any one of Examples 23-29, and optionally, wherein the multi-AP parameter field comprises a direction field to indicate whether at least one of Uplink (UL) communication or Downlink (DL) communication is to be allowed during the TWT SP.

Example 31 includes the subject matter of any one of Examples 23-30, and optionally, wherein the multi-AP parameter field comprises a backoff field configured to indicate a duration of a backoff to be applied for channel access during the TWT SP, wherein the apparatus is configured to cause the STA to configure a backoff of the STA during the TWT SP based on the backoff field.

Example 32 includes the subject matter of any one of Examples 23-31, and optionally, wherein the multi-AP parameter field comprises a multi-AP coordinated information field comprising multi-AP coordinated information to configure multi-AP coordinated communications during the TWT SP.

Example 33 includes the subject matter of any one of Examples 23-32, and optionally, wherein the multi-AP parameter field comprises one or more multi-AP coordinated communication parameters, which are coordinated by the AP and one or more other APs, wherein the one or more multi-AP coordinated communication parameters configure communication during the TWT SP.

Example 34 includes the subject matter of any one of Examples 23-33, and optionally, wherein the multi-AP parameter field comprises one or more multi-AP coordinated communication parameters coordinated by a plurality of APs, which are to share the TWT SP.

Example 35 includes the subject matter of Example 34, and optionally, wherein the plurality of APs comprises a plurality of APs to share the TWT SP according to a time diversity scheme.

Example 36 includes the subject matter of Example 34 or 35, and optionally, wherein the plurality of APs comprises a plurality of APs to share the TWT SP according to a frequency diversity scheme.

Example 37 includes the subject matter of any one of Examples 34-36, and optionally, wherein the plurality of APs comprises a plurality of APs to share the TWT SP according to a spatial reuse scheme.

Example 38 includes the subject matter of any one of Examples 23-37, and optionally, wherein the TWT SP comprises a restricted TWT (rTWT) SP.

Example 39 includes the subject matter of any one of Examples 23-38, and optionally, wherein the multi-AP parameter field is after a restricted TWT traffic information field in the TWT parameter set field.

Example 40 includes the subject matter of any one of Examples 23-39, and optionally, wherein the apparatus is configured to process a broadcast transmission comprising the TWT element, wherein the TWT parameter set field comprises a broadcast TWT parameter set field.

Example 41 includes the subject matter of any one of Examples 23-40, and optionally, wherein the apparatus is configured to process a beacon comprising the TWT element.

Example 42 includes the subject matter of any one of Examples 23-41, and optionally, comprising at least one radio to receive the TWT element.

Example 43 includes the subject matter of Example 42, and optionally, comprising one or more antennas connected to the radio, and a processor to execute instructions of an operating system of the STA.

Example 44 comprises a wireless communication device comprising the apparatus of any of Examples 1-43.

Example 45 comprises an apparatus comprising means for executing any of the described operations of any of Examples 1-43.

Example 46 comprises a product comprising one or more tangible computer-readable non-transitory storage media comprising instructions operable to, when executed by at least one processor, enable the at least one processor to cause a wireless communication device to perform any of the described operations of any of Examples 1-43.

Example 47 comprises an apparatus comprising: a memory interface; and processing circuitry configured to: perform any of the described operations of any of Examples 1-43.

Example 48 comprises a method comprising any of the described operations of any of Examples 1-43.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1.-25. (canceled)

26. An apparatus comprising logic and circuitry configured to cause an Access Point (AP) to:
set a multi-AP parameter field in a Target Wake Time (TWT) parameter set field, wherein the multi-AP parameter field comprises information to configure multi-AP operation during a TWT Service Period (SP); and
transmit a TWT element, wherein the TWT element comprises the TWT parameter set field.

27. The apparatus of claim 26, wherein the multi-AP parameter field comprises a Transmit (Tx) power constraint field configured to indicate a constraint on a Tx power for transmission during the TWT SP.

28. The apparatus of claim 26, wherein the multi-AP parameter field comprises a maximal Transmit (Tx) power field configured to indicate a maximal Tx power for transmission during the TWT SP.

29. The apparatus of claim 26, wherein the multi-AP parameter field comprises a Power Spectral Density (PSD) limit field configured to indicate a PSD limit for transmission during the TWT SP.

30. The apparatus of claim 26, wherein the multi-AP parameter field comprises user-restriction information configured to restrict a count of users to communicate during the TWT SP.

31. The apparatus of claim 26, wherein the multi-AP parameter field comprises Enhanced Distributed Channel Access (EDCA) restriction information configured to indicate an EDCA restriction during the TWT SP.

32. The apparatus of claim 31, wherein the EDCA restriction information is configured to indicate that EDCA during the TWT SP is restricted to members of a TWT schedule.

33. The apparatus of claim 26, wherein the multi-AP parameter field comprises a direction field to indicate whether at least one of Uplink (UL) communication or Downlink (DL) communication is to be allowed during the TWT SP.

34. The apparatus of claim 26, wherein the multi-AP parameter field comprises a backoff field configured to indicate a duration of a backoff to be applied for channel access during the TWT SP.

35. The apparatus of claim 26, wherein the multi-AP parameter field comprises a multi-AP coordinated information field comprising multi-AP coordinated information to configure multi-AP coordinated communications during the TWT SP.

36. The apparatus of claim 26, wherein the multi-AP parameter field comprises one or more multi-AP coordinated communication parameters, which are coordinated by the AP and one or more other APs, wherein the one or more multi-AP coordinated communication parameters configure communication during the TWT SP.

37. The apparatus of claim 26, wherein the multi-AP parameter field comprises one or more multi-AP coordinated communication parameters coordinated by a plurality of APs, which are to share the TWT SP.

38. The apparatus of claim 37, wherein the plurality of APs comprises a plurality of APs to share the TWT SP according to a time diversity scheme.

39. The apparatus of claim 37, wherein the plurality of APs comprises a plurality of APs to share the TWT SP according to a frequency diversity scheme.

40. The apparatus of claim 37, wherein the plurality of APs comprises a plurality of APs to share the TWT SP according to a spatial reuse scheme.

41. The apparatus of claim 37 configured to cause the AP to transmit a multi-AP sharing trigger frame during a Transmit Opportunity (TxOP) obtained by the AP during the TWT SP, wherein the multi-AP sharing trigger frame is to trigger multi-AP sharing of the TxOP.

42. The apparatus of claim 26, wherein the TWT SP comprises a restricted TWT (rTWT) SP.

43. The apparatus of claim 26 comprising at least one radio to transmit the TWT element, one or more antennas connected to the radio, and a processor to execute instructions of an operating system.

44. An apparatus comprising logic and circuitry configured to cause a wireless communication station (STA) to:
identify a multi Access Point (AP) (multi-AP) parameter field in a Target Wake Time (TWT) parameter set field of a TWT element from an AP, wherein the multi-AP parameter field comprises information to configure multi-AP operation during a TWT Service Period (SP); and
communicate one or more transmissions during the TWT SP based on the multi-AP parameter field.

45. The apparatus of claim 44, wherein the multi-AP parameter field comprises a Transmit (Tx) power constraint field configured to indicate a constraint on a Tx power for transmission during the TWT SP, wherein the apparatus is configured to cause the STA to constrain a Tx power of the STA for a transmission during the TWT SP based on the Tx power constraint field.
